(19) United States
(12) Patent Application Publication
(10) Pub. No.: US 2024/0047815 A1
(43) Pub. Date: Feb. 8, 2024

(54) PRESSURE EQUALIZATION DEVICES FOR TRACTION BATTERY PACKS

(71) Applicant: FORD GLOBAL TECHNOLOGIES, LLC, Dearborn, MI (US)

(72) Inventors: Alexander Robert RINK, Royal Oak, MI (US); Nathaniel CONTI, Canton, MI (US); Parikshit S. GUPTE, West Bloomfield, MI (US); Ryan Scott GRAY, Farmington Hills, MI (US)

(21) Appl. No.: 17/882,736

(22) Filed: Aug. 8, 2022

(51) Int. Cl. H01M 50/333; H01M 50/375

(52) U.S. Cl. CPC H01M 50/333; H01M 50/375; H01M 2220/20

(57) ABSTRACT

Traction battery pack designs are disclosed for use in electrified vehicles. Exemplary traction battery packs may include an outer enclosure assembly establishing an interior, and a battery array housed within the interior. A pressure equalization device may be disposed within a wall of the outer enclosure assembly and may be configured to both equalize the pressure inside the battery pack during normal battery operations and to prevent the unintended release of battery vent byproducts during battery thermal events.

### TECHNICAL FIELD

This disclosure relates generally to electrified vehicle traction battery packs, and more particularly to pressure equalization devices for traction battery packs.

### BACKGROUND

A high voltage traction battery pack typically powers an electric machine and other electrical loads of an electrified vehicle. The traction battery pack includes a plurality of battery cells and various other battery internal components that are housed inside an outer enclosure assembly for supporting the electric propulsion of the vehicle. The outer enclosure assembly must be sealed and vented to prevent moisture from accumulating within the interior of the battery pack. Temperature fluctuations inside the battery pack can create pressure differentials between the battery interior and its surrounding atmosphere.

### SUMMARY

A traction battery pack according to an exemplary aspect of the present disclosure includes, among other things, an outer enclosure assembly, and a pressure equalization device received within a wall of the outer enclosure assembly. The pressure equalization device includes a housing and a valve configured to close a gas path through the housing during a battery thermal event of the traction battery pack.

In a further non-limiting embodiment of the foregoing traction battery pack, the valve is a poppet valve configured to move between a first position and a second position relative to the housing.

In a further non-limiting embodiment of either of the foregoing traction battery packs, the valve is spaced apart from a sealing surface of the housing in the first position and is received against the sealing surface in the second position.

In a further non-limiting embodiment of any of the foregoing traction battery packs, the valve is biased apart from the sealing surface by a spring when in the first position.

In a further non-limiting embodiment of any of the foregoing traction battery packs, the valve is separated from the sealing surface by a thermostatic actuator when in the first position.

In a further non-limiting embodiment of any of the foregoing traction battery packs, the thermostatic actuator is configured as a wax ring.

In a further non-limiting embodiment of any of the foregoing traction battery packs, the valve is held apart from the sealing surface by a frangible connector when in the first position.

In a further non-limiting embodiment of any of the foregoing traction battery packs, the valve includes an intumescent coating that is configured to expand to close the gas path.

In a further non-limiting embodiment of any of the foregoing traction battery packs, the pressure equalization device includes a water-impermeable membrane held within the housing.

In a further non-limiting embodiment of any of the foregoing traction battery packs, the water-impermeable membrane is configured to allow a gas to exit the pressure equalization device through the gas path when the valve is not closing the gas path.

In a further non-limiting embodiment of any of the foregoing traction battery packs, the housing is dome-shaped. The wall is part of an enclosure tray of the outer enclosure assembly.

In a further non-limiting embodiment of any of the foregoing traction battery packs, a plurality of battery arrays is housed inside the outer enclosure assembly.

A traction battery pack according to another exemplary aspect of the present disclosure includes, among other things, an outer enclosure assembly establishing an interior, a battery array housed within the interior, and a pressure equalization device configurable between a first configuration in which a gas path established by an internal bore of a housing of the pressure equalization device is open and a second configuration in which the gas path is closed.

In a further non-limiting embodiment of the foregoing traction battery pack, the pressure equalization device includes a valve that is movable between a first position and a second position to close the gas path.

In a further non-limiting embodiment of either of the foregoing battery packs, the valve is spaced apart from a sealing surface of the housing when in the first position and is received against the sealing surface when in the second position.

In a further non-limiting embodiment of any of the foregoing battery packs, the valve is biased apart from the sealing surface by a spring when in the first position.

In a further non-limiting embodiment of any of the foregoing battery packs, the valve is separated from the sealing surface by a thermostatic actuator when in the first position.

In a further non-limiting embodiment of any of the foregoing battery packs, the valve is held apart from the sealing surface by a frangible connector when in the first position.

In a further non-limiting embodiment of any of the foregoing battery packs, the valve includes an intumescent coating that is configured to expand to close the gas path.

In a further non-limiting embodiment of any of the foregoing battery packs, the pressure equalization device includes a water-impermeable membrane held within the housing.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 schematically illustrates an electrified vehicle.

FIG. 2 is a perspective view of a traction battery pack for an electrified vehicle.

FIG. 3 is a perspective view of another exemplary traction battery pack.

FIG. 4 is a cross-sectional view through section 4-4 of FIG. 2 and illustrates features associated with a pressure equalization device of the traction battery pack.

FIG. 5 illustrates another exemplary pressure equalization device.

FIG. 6 illustrates another exemplary pressure equalization device.

FIGS. 7A and 7B illustrate yet another exemplary pressure equalization device.

### DETAILED DESCRIPTION

This disclosure details exemplary traction battery pack designs for use in electrified vehicles. Exemplary traction battery packs may include an outer enclosure assembly establishing an interior, and a battery array housed within the interior. A pressure equalization device may be disposed within a wall of the outer enclosure assembly and may be configured to both equalize the pressure inside the battery pack during normal battery operations and to prevent the unintended release of battery vent byproducts during battery thermal events. These and other features are discussed in greater detail in the following paragraphs of this detailed description.

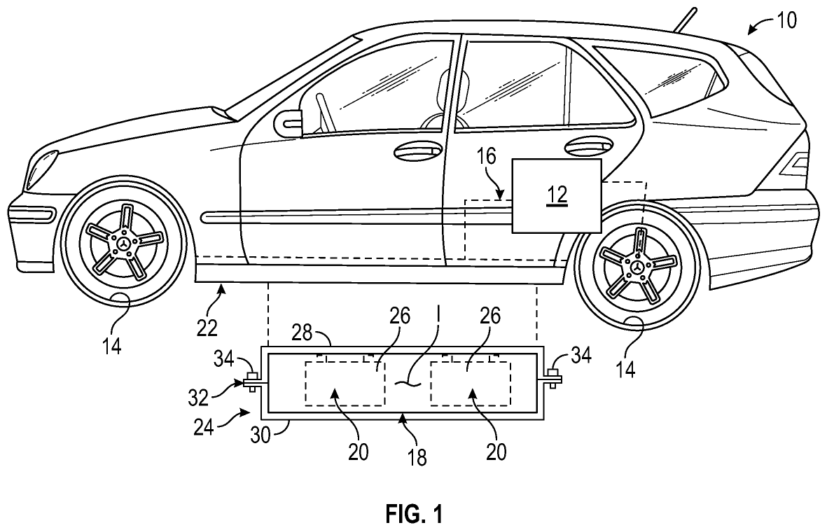

FIG. 1 schematically illustrates an electrified vehicle 10. The electrified vehicle 10 may include any type of electrified powertrain. In an embodiment, the electrified vehicle 10 is a battery electric vehicle (BEV). However, the concepts described herein are not limited to BEVs and could extend to other electrified vehicles, including, but not limited to, hybrid electric vehicles (HEVs), plug-in hybrid electric vehicles (PHEV's), fuel cell vehicles, etc. Therefore, although not specifically shown in the exemplary embodiment, the electrified vehicle 10 could be equipped with an internal combustion engine that can be employed either alone or in combination with other power sources to propel the electrified vehicle 10.

In the illustrated embodiment, the electrified vehicle 10 is a sport utility vehicle (SUV). However, the electrified vehicle 10 could alternatively be a car, a van, a pickup truck, or any other vehicle configuration. Although a specific component relationship is illustrated in the figures of this disclosure, the illustrations are not intended to limit this disclosure. The placement and orientation of the various components of the electrified vehicle 10 are shown schematically and could vary within the scope of this disclosure. In addition, the various figures accompanying this disclosure are not necessarily drawn to scale, and some features may be exaggerated or minimized to emphasize certain details of a particular component or system.

In the illustrated embodiment, the electrified vehicle 10 is a full electric vehicle propelled solely through electric power, such as by one or more electric machines 12, without assistance from an internal combustion engine. The electric machine 12 may operate as an electric motor, an electric generator, or both. The electric machine 12 receives electrical power and can convert the electrical power to torque for driving one or more wheels 14 of the electrified vehicle 10

A voltage bus 16 may electrically couple the electric machine 12 to a traction battery pack 18. The traction battery pack 18 is an exemplary electrified vehicle battery. The traction battery pack 18 may be a high voltage traction battery pack that includes one or more battery arrays 20 (i.e., battery assemblies or groupings of rechargeable battery cells 26) capable of outputting electrical power to power the electric machine 12 and/or other electrical loads of the electrified vehicle 10. Other types of energy storage devices and/or output devices could alternatively or additionally be used to electrically power the electrified vehicle 10.

The battery cells 26 may be stacked side-by-side along a stack axis to construct a grouping of battery cells 26, sometimes referred to as a “cell stack.” In the highly schematic depiction of FIG. 1, the battery cells 26 are stacked in a direction into the page to construct each battery array 20, and thus the battery arrays 20 extend in cross-car direction. However, other configurations may also be possible.

The total number of battery arrays 20 and battery cells 26 provided within the traction battery pack 18 is not intended to limit this disclosure. In an embodiment, the battery cells 26 of each battery array 20 are prismatic, lithium-ion cells. However, battery cells having other geometries (cylindrical, pouch, etc.), other chemistries (nickel-metal hydride, lead-acid, etc.), or both could alternatively be utilized within the scope of this disclosure.

The traction battery pack 18 may be secured to an underbody 22 of the electrified vehicle 10. However, the traction battery pack 18 could be located elsewhere on the electrified vehicle 10 within the scope of this disclosure.

An outer enclosure assembly 24 may house each battery array 20 of the traction battery pack 18. The outer enclosure assembly 24 may be a sealed enclosure and may embody any size, shape, and configuration within the scope of this disclosure. In an embodiment, the outer enclosure assembly 24 includes an enclosure cover 28 and an enclosure tray 30. Together, the enclosure cover 28 and the enclosure tray 30 may establish an interior I for housing the battery arrays 20 and other battery internal components (e.g., bussed electrical center, battery electric control module, wiring, connectors, etc.) of the traction battery pack 18.

During assembly of the traction battery pack 18, the enclosure cover 28 may be secured to the enclosure tray 30 at an interface 32 therebetween. The interface 32 may substantially circumscribe the interior I. In some implementations, mechanical fasteners 34 may be used to secure the enclosure cover 28 to the enclosure tray 30, although other fastening methodologies (adhesion, etc.) could also be suitable for this purpose.

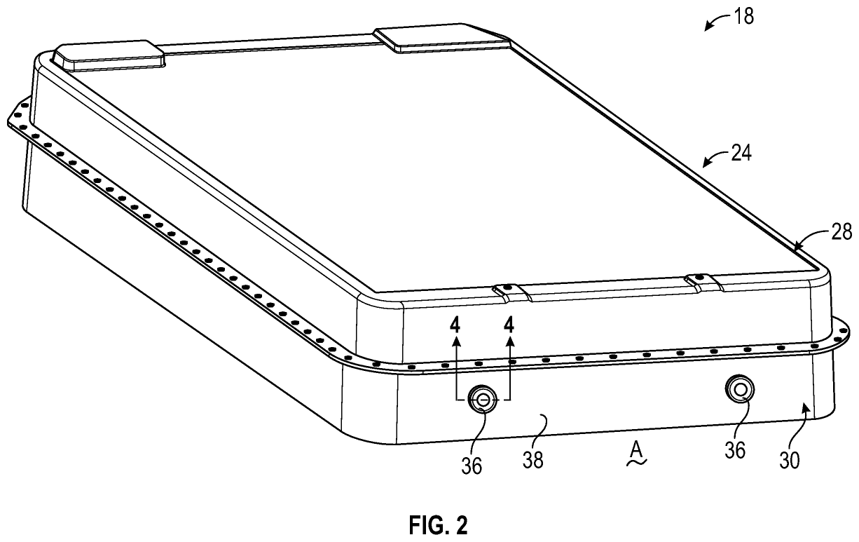

Referring now to FIG. 2, with continued reference to FIG. 1, the traction battery pack 18 may include one or more pressure equalization devices 36. Although two pressure equalization devices 36 are shown, the traction battery pack 18 may include a greater or fewer number of such devices.

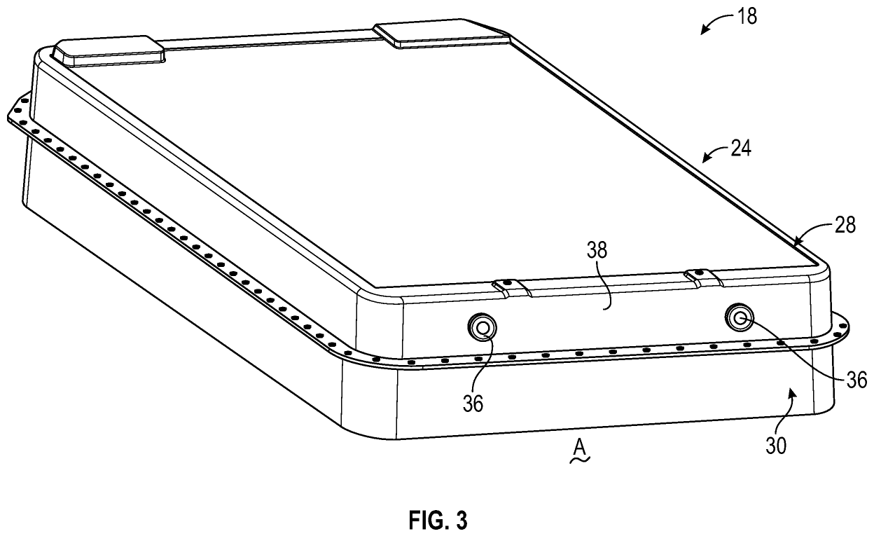

Each pressure equalization device 36 may be disposed within a wall 38 of the outer enclosure assembly 24. In an embodiment, the wall 38 is part of the enclosure tray 30. In another embodiment, the wall 38 is part of the enclosure cover 28 (see FIG. 3). However, the exact mounting location of each pressure equalization device 36 could vary and is therefore not intended to limit this disclosure.

The pressure equalization devices 36 may be secured to the wall 38 in any manner. In an embodiment, each pressure equalization device 36 is secured within the wall 38 via a quarter turn mount. However, the pressure equalization devices 36 could alternatively or additionally be mounted via mechanical fasteners, cam locks, adhesion, etc.

Each pressure equalization device 36 may be configured to provide pressure equalization between the interior I of the traction battery pack 18 and an atmosphere A outside of the traction battery pack 18. For example, during normal battery operations, the pressure equalization devices 36 may allow gases (e.g., air) to flow in and out of the outer enclosure assembly 24 while preventing moisture, particle contaminants, etc. from entering the interior I of the traction battery pack 18.

There may be some operating conditions in which it is undesirable for gases to escape through the pressure equalization devices 36. For example, battery thermal events may occur during over-temperature, over-charging, or over-discharging conditions of the battery cells 26, or during other battery cell conditions. Battery vent byproducts may be released from one or more battery cells 26 of the battery arrays 20 during these conditions. If permitted to escape through the pressure equalization devices 36, the battery vent byproducts could permeate to undesirable areas of the vehicle. This disclosure is therefore directed to pressure equalization devices that are capable of both providing pressure equalization during normal battery operations and prohibiting battery vent byproducts from escaping the traction battery pack 18 through the pressure equalization devices during battery thermal events.

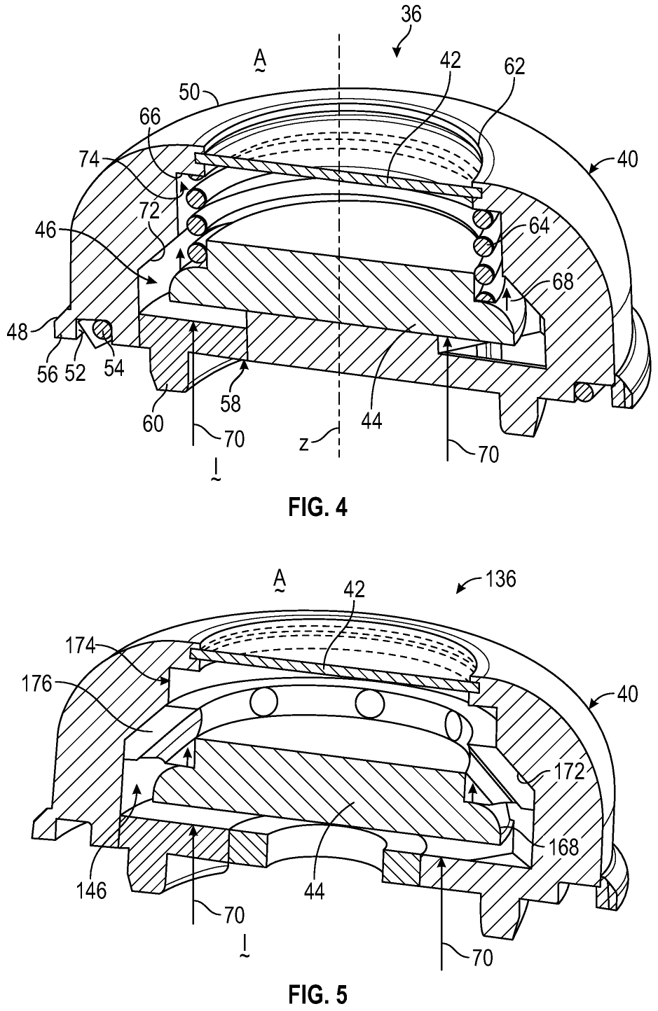

FIG. 4, with continued reference to FIGS. 1-2, illustrates an exemplary pressure equalization device 36 for the traction battery pack 18. The pressure equalization device 36 may include a housing 40, a water-impermeable membrane 42, and an integrated valve 44. The housing 40 may include an internal bore 46, and each of the water-impermeable membrane 42 and the valve 44 may be accommodated within different sections of the internal bore 46.

The housing 40 may be a plastic component or a metallic component and may include a single-piece structure or a multi-piece structure. In an embodiment, the housing 40 is dome-shaped. However, the size and shape of the housing 40 is not intended to limit this disclosure.

The housing 40 may be oriented along a central axis Z. The housing 40 may include an interior section 48 that interfaces with the wall 38 of the outer enclosure assembly 24 and an outer section 50 that protrudes outwardly of the wall 38 (see FIG. 2). A groove 52 may be formed a rear surface 56 of the interior section 48, and a seal 54 may be received within the groove 52. The seal 54 may be configured to seal the interface between the wall 38 of the outer enclosure assembly 24 and the housing 40 of the pressure equalization device 36. The seal 54 could be a bore seal, an adhesive seal, a press-in-place seal, a carrier gasket, a form in place sealant, or any other suitable sealing device/agent.

The interior section 48 of the housing 40 may additionally include an attachment portion 58. The attachment portion 58 may be circumscribed by the groove 52. The attachment portion 58 may include a boss feature 60 that may be configured to establish a quarter turn mount for securing the housing 40 within the wall 38 of the outer enclosure assembly 24.

The internal bore 46 may include an outer opening 62 formed in the outer section 50 of the housing 40. The water-impermeable membrane 42 may be received within the housing 40 so as to substantially cover the outer opening 62. The water-impermeable membrane 42 may be a patch, filter, or some other porous membrane that allow gases to flow in and out of the outer enclosure assembly 24 while preventing moisture, particle contaminants, etc. from entering the interior I of the traction battery pack 18 during normal battery operations. The water-impermeable membrane 42 therefore provides pressure equalization between the interior I of the traction battery pack 18 and atmosphere A.

The valve 44 may be received within the internal bore 46 at a location between the attachment portion 58 and the water-impermeable membrane 42. In a first or default position, the valve 44 is biased in a direction away from the water-impermeable membrane 42 by a spring 64. The spring 64 may be positioned to extend between a biasing surface 66 of the housing 40 and an outer flange 68 of the valve 44. Gases received from the interior I of the traction battery pack 18 may flow through the internal bore 46 and then exit the pressure equalization device 36 through the water-impermeable membrane 42 when the valve 44 is in the first/default position. In other words, a gas path through the internal bore 46 is not closed off when the valve 44 is located in the first/default position.

The valve 44 may be configured as a poppet valve that can move from the first/default position to a second or actuated position during battery thermal events. For example, during a battery thermal event, battery vent byproducts 70 that are released by the battery cells 26 can increase the pressure inside the interior I of the traction battery pack 18. When the increased pressure exceeds a predefined threshold, the pressure may overcome the biasing force of the spring 64, thereby forcing the valve 44 to move to the second/actuated position. In the second/actuated position, the outer flange 68 of the valve 44 may be moved into contact with a sealing surface 72 of the housing 40, and thus, gases are no longer able to permeate through the gas path established by the internal bore 46 of the pressure equalization device 36. The sealing surface 72 may be established by an angled portion of an inner diameter wall 74 of the housing 40, for example. The inner diameter wall 74 circumscribes the internal bore 46 of the housing 40.

Battery vent byproducts 70 that are released by battery cells 26 of the traction battery pack 18 during the battery thermal event are prevented from exiting from the pressure equalization device 36 when the valve 44 is in the second/actuated position. The battery vent byproducts 70 may therefore be forced to exit the traction battery pack 18 only through separate venting channels as part of a dedicated venting management strategy of the traction battery pack 18.

Although illustrated a conical poppet-type valve in FIG. 4, the valve 44 could embody other configurations within the scope of this disclosure. For example, the valve 44 could be a prismatic valve, a ball valve, etc.

FIG. 5 illustrates another exemplary pressure equalization device 136. Like the pressure equalization device 36 discussed above, the pressure equalization device 136 is capable of providing the dual function of equalizing the pressure inside the traction battery pack 18 during normal battery conditions and preventing the unintended release of battery vent byproducts 70 during battery thermal events.

The pressure equalization device 136 may include a housing 140, a water-impermeable membrane 142, and an integrated valve 144. The pressure equalization device 136 may further include a thermostatic actuator 176. The thermostatic actuator 176 may be configured as a wax ring that is positioned between the valve 144 and a sealing surface 172 of an inner diameter wall 174 of the housing 140.

In a first or default position, the valve 144 is displaced apart from the sealing surface 172 by the thermostatic actuator 176. Gases received from the interior I of the traction battery pack 18 may therefore flow through an internal bore 146 of the housing 140 and then exit the pressure equalization device 136 through the water-impermeable membrane 142 when the valve 144 is in the first/default position. In other words, a gas path through the internal bore 146 is not closed off when the valve 144 is located in the first/default position.

The valve 144 may be automatically moved from the first/default position to a second or actuated position during battery thermal events. For example, during a battery thermal event, battery vent byproducts 70 that are released by the battery cells 26 can increase the temperature inside the interior I of the traction battery pack 18. When the temperature exceeds a predefined threshold, the thermostatic actuator 176 may melt, thereby permitting the valve 144 to move to the second/actuated position. In the second/actuated position, an outer flange 168 of the valve 144 may be moved into contact with the sealing surface 172, thereby closing the gas path such that gases are no longer able to permeate through the internal bore 146 of the pressure equalization device 136.

Battery vent byproducts 70 that are received by the pressure equalization device 136 from the interior I of the traction battery pack 18 during the battery thermal event are prevented from exiting from the pressure equalization device 136 when the valve 144 is in the second/actuated position. The battery vent byproducts 70 may therefore be forced to exit the traction battery pack 18 only through separate venting channels as part of a dedicated venting management strategy of the traction battery pack 18.

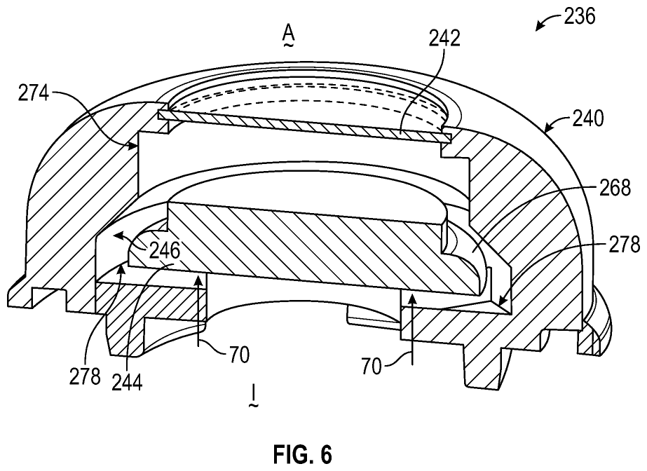

FIG. 6 illustrates another exemplary pressure equalization device 236. Like the pressure equalization devices discussed above, the pressure equalization device 236 is capable of providing the dual function of equalizing pressure inside the traction battery pack 18 during normal battery conditions and preventing the unintended release of battery venting byproducts 70 during battery thermal events.

The pressure equalization device 236 may include a housing 240, a water-impermeable membrane 242, and an integrated valve 244. The pressure equalization device 236 may further include one or more frangible connectors 278 that secure the valve 244 to the housing 240. The frangible connectors 278 are shown schematically but could embody a variety of configurations (e.g., sacrificial tabs, etc.) for maintaining a desired position of the valve 244 within the housing 244 during normal battery operations.

In a first or default position, the valve 244 is held apart from a sealing surface 272 of the housing 240 by the frangible connectors 278. Gases received from the interior I of the traction battery pack 18 may therefore flow through an internal bore 246 of the housing 240 and then exit the pressure equalization device 236 through the water-impermeable membrane 242 when the valve 244 is in the first/default position. In other words, a gas path through the internal bore 246 is not closed off when the valve 244 is located in the first/default position.

The valve 244 may be automatically moved from the first/default position to a second or actuated position during battery thermal events. For example, during a battery thermal event, battery vent byproducts 70 that are released by the battery cells 26 can increase the temperature and pressure inside the interior I of the traction battery pack 18. When the pressure exceeds a predefined threshold, the frangible connectors 278 may fracture, thereby permitting the valve 244 to disengage from the housing 240 and move to the second/actuated position. In the second/actuated position, an outer flange 268 of the valve 244 may be moved into contact with the sealing surface 272, and thus, gases are no longer able to permeate through the internal bore 246 of the pressure equalization device 236.

Battery vent byproducts 70 that are received by the pressure equalization device 236 from the interior I of the traction battery pack 18 during the battery thermal event are prevented from exiting from the pressure equalization device 236 when the valve 244 is in the second/actuated position. The battery vent byproducts 70 may therefore be forced to exit the traction battery pack 18 only through separate venting channels as part of a dedicated venting management strategy of the traction battery pack 18.

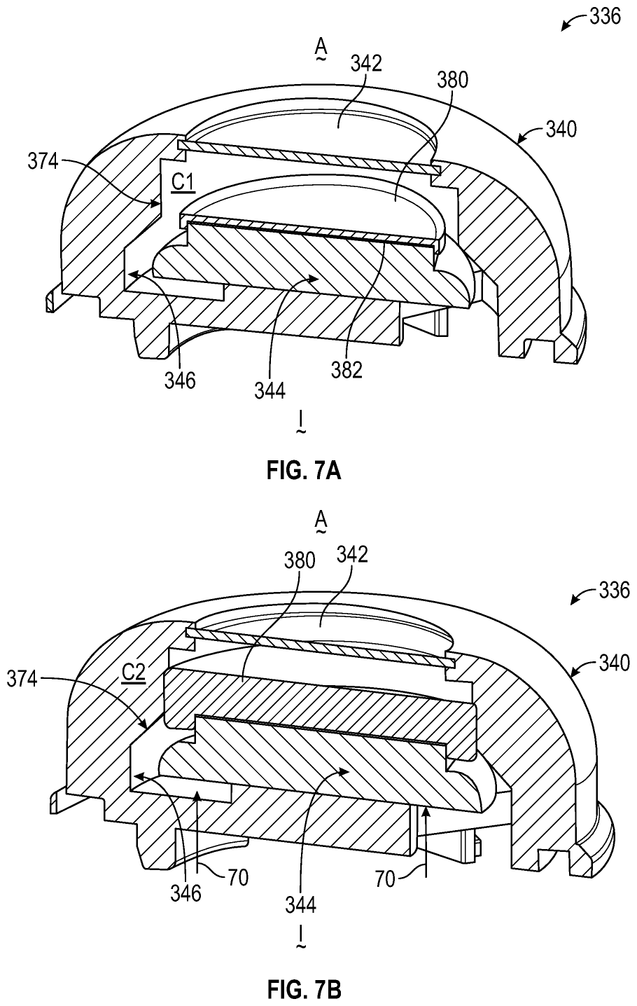

FIGS. 7A and 7B illustrate yet another exemplary pressure equalization device 336. Like the pressure equalization devices discussed above, the pressure equalization device 336 is capable of providing the dual function of equalizing pressure inside the traction battery pack 18 during normal battery conditions and preventing the unintended release of battery venting byproducts during battery thermal events.

The pressure equalization device 336 may include a housing 340, a water-impermeable membrane 342, and an integrated valve 344. The valve 344 may be fixedly secured to the housing 340.

In this embodiment, the valve 344 may further include a material 380 that expands upon exposure to high heat. The material 380 may be applied to the top surface 382 of the valve 344, although other locations could be suitable. The material 380 may be a thermally activated expandable material, such as an intumescent coating or any other material that expands when exposed to relatively high temperatures.

A first or default position of the valve 344 is shown in FIG. 7A. In the first/default position, the material 380 includes a non-expanded configuration C1, and therefore an internal bore 346 of the housing 340 is unobstructed by any portion of the valve 344. Gases received from the interior I of the traction battery pack 18 may therefore flow through the internal bore 346 of the housing 340 and then exit the pressure equalization device 336 through the water-impermeable membrane 342 when the valve 344 is in the first/default position.

A second or actuated position of the valve 344 is shown in FIG. 7B. In the second/actuated position, the internal bore 346 is blocked by portions of the valve 344. For example, during a battery thermal event, battery vent byproducts 70 that are released by the battery cells 26 can increase the temperature and pressure inside the interior I of the traction battery pack 18. When the temperature exceeds a predefined threshold, the material 380 may expand to an expanded configuration C2. In the expand configuration C2, the material 380 contacts a portion of an inner diameter wall 374, thereby closing off the gas path through the internal bore 346. Battery vent byproducts 70 that are received by the pressure equalization device 336 from the interior I of the traction battery pack 18 during the battery thermal event are thus prevented from exiting from the pressure equalization device 336 when the valve 344 is in the second/actuated position. The battery vent byproducts 70 may therefore be forced to exit the traction battery pack 18 only through separate venting channels as part of a dedicated venting management strategy of the traction battery pack 18.

Notably, the material 380 of the embodiment of FIGS. 7A and 7B could be utilized either alone or in combination with any of the valves shown in FIGS. 4, 5, and 6.

The exemplary traction battery packs of this disclosure incorporate pressure equalization devices that serve the dual function of equalizing pressure inside the traction battery pack during normal battery conditions and preventing the unintended release of battery venting byproducts during battery thermal events. The proposed devices are relatively simple and inexpensive to assemble and manufacture and do not require complex modifications to the battery pack sealing strategy.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A traction battery pack, comprising:
an outer enclosure assembly; and
a pressure equalization device received within a wall of the outer enclosure assembly,
wherein the pressure equalization device includes a housing and a valve configured to close a gas path through the housing during a battery thermal event of the traction battery pack.

2. The traction battery pack as recited in claim 1, wherein the valve is a poppet valve configured to move between a first position and a second position relative to the housing.

3. The traction battery pack as recited in claim 2, wherein the valve is spaced apart from a sealing surface of the housing in the first position and is received against the sealing surface in the second position.

4. The traction battery pack as recited in claim 3, wherein the valve is biased apart from the sealing surface by a spring when in the first position.

5. The traction battery pack as recited in claim 3, wherein the valve is separated from the sealing surface by a thermostatic actuator when in the first position.

6. The traction battery pack as recited in claim 5, wherein the thermostatic actuator is configured as a wax ring.

7. The traction battery pack as recited in claim 3, wherein the valve is held apart from the sealing surface by a frangible connector when in the first position.

8. The traction battery pack as recited in claim 1, wherein the valve includes a thermally activated expandable material that is configured to expand to close the gas path.

9. The traction battery pack as recited in claim 1, wherein the pressure equalization device includes a water-impermeable membrane held within the housing.

10. The traction battery pack as recited in claim 9, wherein the water-impermeable membrane is configured to allow a gas to exit the pressure equalization device through the gas path when the valve is not closing the gas path.

11. The traction battery pack as recited in claim 1, wherein the housing is dome-shaped, and further wherein the wall is part of an enclosure tray of the outer enclosure assembly.

12. The traction battery pack as recited in claim 1, comprising a plurality of battery arrays housed inside the outer enclosure assembly.

13. A traction battery pack, comprising:
an outer enclosure assembly establishing an interior;
a battery array housed within the interior; and
a pressure equalization device configurable between a first configuration in which a gas path established by an internal bore of a housing of the pressure equalization device is open and a second configuration in which the gas path is closed.

14. The traction battery pack as recited in claim 13, wherein the pressure equalization device includes a valve that is movable between a first position and a second position to close the gas path.

15. The battery pack as recited in claim 14, wherein the valve is spaced apart from a sealing surface of the housing when in the first position and is received against the sealing surface when in the second position.

16. The battery pack as recited in claim 15, wherein the valve is biased apart from the sealing surface by a spring when in the first position.

17. The battery pack as recited in claim 15, wherein the valve is separated from the sealing surface by a thermostatic actuator when in the first position.

18. The battery pack as recited in claim 15, wherein the valve is held apart from the sealing surface by a frangible connector when in the first position.

19. The battery pack as recited in claim 14, wherein the valve includes a thermally activated expandable material that is configured to expand to close the gas path.

20. The battery pack as recited in claim 13, wherein the pressure equalization device includes a water-impermeable membrane held within the housing.
